(19) United States
(12) Patent Application Publication
(10) Pub. No.: US 2012/0026174 A1
(43) Pub. Date: Feb. 2, 2012

(54) Method and Apparatus for Character Animation

(75) Inventors: Thomas F. McKeon, Evanston, IL (US); John Molinari, Santa Rosa, CA (US)

(73) Assignee: SONOMA DATA SOLUTION, LLC, Santa Rosa, CA (US)

(21) Appl. No.: 13/263,909

(22) PCT Filed: Apr. 27, 2010
(86) PCT No.: PCT/US10/32539

§ 371 Date: Oct. 11, 2011

Related U.S. Application Data
(62) Division of application No. 61/214,644, filed on Apr. 27, 2009.

(51) Int. Cl. G06T 13/00

(52) U.S. Cl. 345/473

(57) ABSTRACT

The present invention provides various means for the animation of character expression in coordination with an audio sound track. The animator selects or creates characters and expressive characteristic from a menu, and then enters the characteristics, including lip and mouth morphology, in coordination with a running sound track.

### CROSS REFERENCE TO RELATED APPLICATIONS

The present application claims the benefit of priority to the US Provisional Patent Application of the same title, which was filed on 27 Apr. 2009, having U.S. application Ser. No. 61/214,644, which is incorporated herein by reference.

The present application also the benefit of priority to the PCT Patent application of the same title that was filed on 27 Apr. 2010, having application serial no. PCT/US2010/032539, which is incorporated herein by reference.

### BACKGROUND OF INVENTION

The present invention relates to character creation and animation in video sequences, and in particular to an improved means for rapid character animation.

Prior methods of character animation via a computer generally requires creating and editing drawings on a frame by frame basis. Although a catalog of computer images of different body and facial features can be used as reference or database to create each frame, the process still is rather laborious, as it requires the manual combination of the different images. This is particularly the case in creating characters whose appearance of speech is to be synchronized with a movie or video sound track.

It is therefore a first object of the present invention to provide better quality animation of facial movement in coordination with the voice portion of such a sound track.

It is yet another aspect of the invention to allow animators to achieve these higher quality results in shorter time that previous animation methods.

It is a further object of the invention to provide a more lifelike animation of the speaking characters in coordination with the voice portion of such a sound track.

### SUMMARY OF THE INVENTION

In the present invention, the first object is achieved by a method of character animation which comprises providing a digital sound track, providing at least one image that is a general facial portrait of a character to be animated, providing a series of images that correspond to at least a portion of the facial morphology that changes when the animated character speaks, wherein each image is associated with a specific phoneme and is selectable via a computer user input device, and then playing the digital sound track, in which the animator is then listening to the digital sound track to determine the sequence and duration of the phonemes intended to be spoken by the animated character, in which the animator is then selecting the appropriate phoneme via the computer user input device, wherein the step of selecting the appropriate phoneme image associated with the causes the image corresponding to the phoneme to be overlaid on the general facial portrait image time sequence corresponding to the time of selection during the play of the digital sound track.

A second aspect of the invention is characterized by providing a data structure for creating animated video frame sequences of characters, the data structure comprising a first data field containing data representing a phoneme and a second data field containing data that is at least one of representing or being associated with an image of the pronunciation of the phoneme contained in the first data field.

A third aspect of the invention is characterized by providing a data structure for creating animated video frame sequences of characters, the data structure comprising a first data field containing data representing an emotional state and a second data field containing data that is at least one of representing or being associated with at least a portion of a facial image associated with a particular emotional state contained in the third data field.

A fourth aspect of the invention is characterized by providing a GUI for character animation that comprises a first frame for displaying a graphical representation of the time elapsed in the play of a digital sound file, a second frame for displaying at least parts of an image of an animated character for a video frame sequence in synchronization with the digital sound file that is graphically represented in the first frame, at least one of an additional frame or a portion of the first and second frame for displaying a symbolic representation of the facial morphology for the animated character to be displayed in the second frame for at least a portion of the graphical representation of the time track in the first frame.

The above and other objects, effects, features, and advantages of the present invention will become more apparent from the following description of the embodiments thereof taken in conjunction with the accompanying drawings.

### BRIEF DESCRIPTION OF THE DRAWINGS

FIG. 1 is a schematic diagram of a Graphic User Interface (GUI) according to one embodiment of the present invention.

FIG. 2 is schematic diagram of the content of the layers that may be combined in the GUI of FIG. 1.

FIG. 3 is a schematic diagram of an alternative GUI.

FIG. 4 is a schematic diagram illustrating an alternative function of the GUI of FIG. 1.

FIG. 5 illustrates a further step in using the GUI in FIG. 4.

FIG. 6 illustrates a further step in using the GUI in FIG. 5.

FIG. 7 is a general schematic diagram of a computer system with a user interface and electronic display with the GUI.

### DETAILED DESCRIPTION

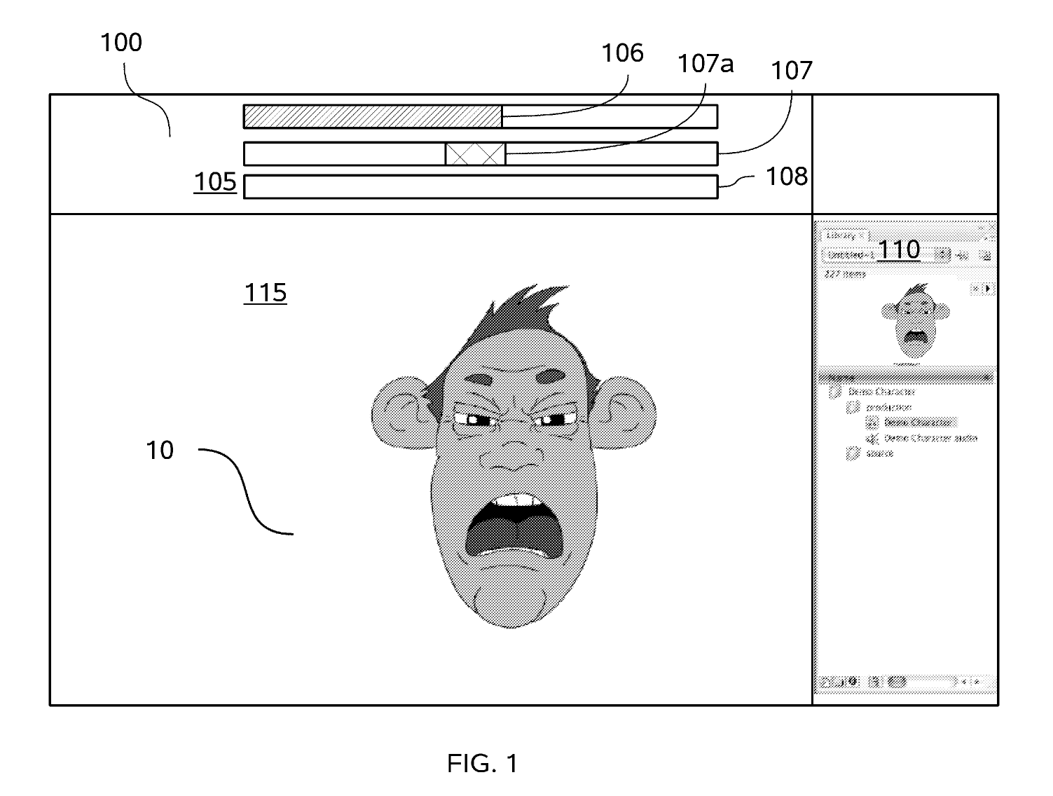

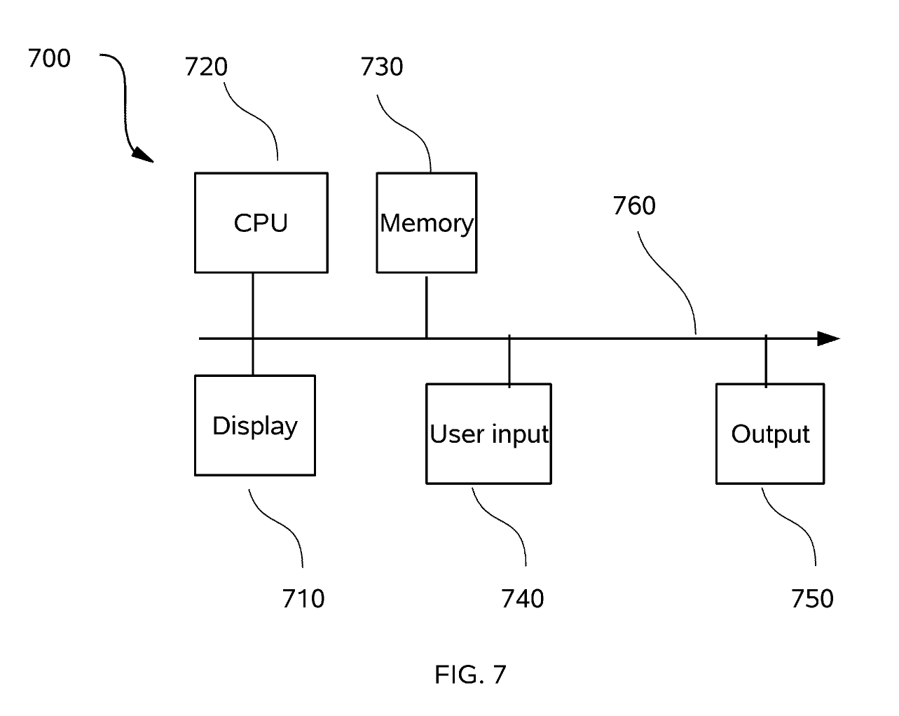

Referring to FIGS. 1 through 7, wherein like reference numerals refer to like components in the various views, there is illustrated therein various aspects of a new and improved method and apparatus for facial character animation, including lip syncing.

In accordance with the present invention, character animation is generated in coordination with a sound track or a script, such as the character's dialog, that includes at least one but preferably a plurality of facial morphologies that represent expressions of emotional states, as well as the apparent verbal expression of sound, that is lip syncing, in coordination with the sound track.

It should be understood that the term facial morphology is intended to include without limitation the appearance of the portions of the head that include eyes, ears, eyebrows, and nose, which includes nostrils, as well as the forehead and cheeks.

It should be appreciated that the animation method deployed herein is intended for implementation on a general purposes computer 700 having an electronic display 710 capable of displaying various Graphic User interfaces described further below. Such a general purpose computer 700 will also have a central processing unit (CPU) 720 as well as memory 730, user input device 740 (such as a keyboard, pen input device or screen, touchscreen, input port, media reader, and the like), as well as at least one output device 750 (such as an audio speaker, output signal port and the like) by a bus 760, and be under the operation of various computer programs, such program being stored on a computer readable storage medium thereof, or an external media reader.

Thus, in one embodiment of the inventive method a video frame sequence of animated characters is created by the animator using such a general purpose computer while auditing a voice sound track (or following a script) to indentify the consonant and vowel phonemes appropriate for the animated display of the character at each instant of time in the video sequence. Upon hearing the phoneme the user actuates a computer input device to signal that the particular phoneme corresponds to either that specific time, or the remaining time duration, at least until another phoneme is selected. The selection step records that a particular image of the character's face should be animated for that selected time sequence, and creates the animated video sequence from a library of image components previously defined. For the English language, this process is relatively straightforward for all 21 consonants, wherein a consonant letter represents the sounds heard. Thus, a standard keyboard provides a useful computer interface device for the selection step. There is one special case: the “th” sound in words like “though”, which has no single corresponding letter. A preferred way to select the “th” sound, via a keyboard, is the simply hold down the “Shift” key while typing “t”. It should be appreciated that any predetermined combination of two or more keys can be used to select a phoneme that does not easily correspond to one key on the keyboard, as may be appropriate to other languages or languages that use non-Latin alphabet keyboards.

Vowels in the English, as well as other languages that do not use a purely phonetic alphabet, can impose an additional complications. Each vowel, unlike consonants, has two separate and distinct sounds. These are called long and short vowel sounds. Preferably when using a computer keyboard as the input device to select the phoneme at least one first key is selected from the letter keys that corresponds with the initial sound of the phoneme and a second key that is not a letter key is used to select the length of the vowel sound. A more preferred way to select the shorter vowel with a keyboard as the computer input device is to hold the “Shift” key while typing a vowel to specify a short sound. Thus, a predetermined image of a facial morphology corresponds to particular consonants and phoneme (or sound) in the language of the sound track.

While the identification of the phoneme is a manual process, the corresponding creation of the video frame filled with the “speaking” character is automated by the program operating on the general purpose computer 700 such that animator's selection, via the computer input device, then causes a predetermined image to be displayed on the electronic display for a fixed or variable duration. In one embodiment the predetermined image is at least a portion of the lips, mouth or jaw to provide “lip syncing” with the vocal sound track. In other embodiments, which are optionally combined with “lip syncing”, the predetermined image can be from a collection of image components that are superimposed or layered in a predetermined order and registration to create the intended composite image. In a preferred embodiment, this collection of images depicts a particular emotional state of the animated character.

It should be appreciated that another aspect of the invention, more fully described with the illustrations of FIG. 1-3 is to provide a Graphical User Interface (GUI) to control and manage the creation and display of different characters, including “lip syncing” and depiction of emotions. The GUI in more preferred embodiments can also provides a series of templates for creating appropriate collection of facial morphologies for different animated characters.

In this mode, the animator selects, using the computer input device, the facial component combination appropriate for the emotional state of the character, as for instance would be apparent from the sound track or denoted in a script for the animated sequence. Then, as directed by the computer program, a collection of facial component images is accumulated and overlaid in the prescribed manner to depict the character with the selected emotional state, as well as then stored in a computer readable media as a new video sequence for reply or transmission to other.

The combination of a particular emotional state and the appearance of the mouth and lips give the animated character a dynamic and life-like appearance that changes over a series of frames in the video sequence.

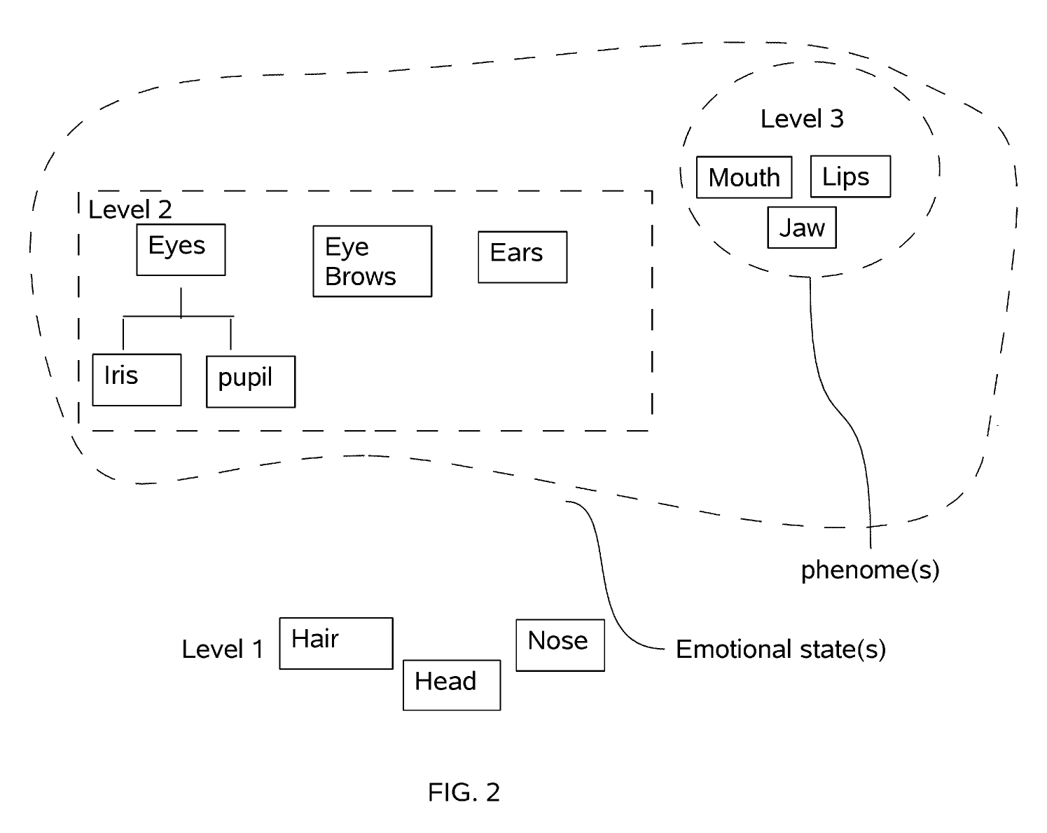

The inventive process preferably deploys the computer generated Graphic User Interface (GUI) 100 shown generally in FIG. 1, with other embodiments shown in the following figures. In this embodiment, GUI 100 allows the animator to play or playback a sound track, such as via a speaker as an output device 750, the progress of which is graphically displayed in a portion or frames 105 (such as the time line bar 106) and simultaneously observe the resulting video frame sequence in the larger lower frame 115. Optionally, to the right of frame 115 is a frame 110 that is generally used as a selection or editing menu. Preferably, as shown in Appendix 1-4, which are incorporated herein by reference, the time bar 106 is filed with a line graph showing the relative sound amplitude on the vertical axis, with elapsed time on the horizontal axis. Below the time line bar 106 is a temporally corresponding bar display 107. Bar display 107 is used to symbolically indicate the animation feature or morphology that was selected for different time durations. Additional bar displays, such as 108, can correspondingly indicate other symbols for a different element or aspect of the facial morphology, as is further defined with reference to FIG. 2. Bar displays 107 and 108 are thus filled in with one or more discrete portion with sub-frames, like 107a, to indicate the status via a parametric representation of the facial morphology for a time represented by the width of the bar. It should be understood that the layout and organization of the frames in the GUI 100 of FIG. 1 is merely exemplary, as the same function can be achieved with different assemblies of the same components described above or their equivalents.

Thus, as the digital sound track is played, the time marker or amplitude graph of timeline bar 106 progresses progress from one end of the bar to the other, while the image of the character 10 in frame 110 is first created in accord with the facial morphology selected by the user/animator. In this manner a complete video sequence is created in temporal coordination with the digital sound track.

In the subsequent re-play of the digital sound track the previously created video sequence is displayed in frame 110, providing the opportunity for the animator to reflect on and improve the life-like quality of the animation thus created. For example, when the sound track is paused, the duration and position of each sub-frame, such as 107a (which define the number and position of video frame 110 filled with the selected image 10) can then be temporally adjusted to improve the coordination with the sound track to make the character appear more life-like. This is preferably done by dragging a handle on the time line bar segment associated with frame 107a or via a key or key stroke combination from a keyboard or other computer user input interface device. In addition, further modifications can be made as in the initial creation step. Normally, the selection of a phoneme or facial expression causes each subsequent frame in the video sequence to have the same selection until a subsequent change is made. The subsequent change is then applied to the remaining frames.

The same or similar GUI can be used to select and insert facial characteristics that simulate the characters emotional state. The facial characteristic is predetermined for the character being animated. Thus, in the more preferred embodiments, other aspects of the method and GUI provides for creation of facial expressions that are coordinated with emotional state of the animated character as would be inferred from the words spoken, as well as the vocal inflection, or any other indications in a written script of the animation.

Some potential aspects of facial morphology are schematically illustrated in FIG. 2 to better explain the step of image synthesis from the components selected with the computer input device. In this figure, facial characteristics are organized in a preferred hierarchy in which they are ultimately overlaid to create or synthesize the image 10 in frame 115. The first layer is the combination of a general facial portrait that would usually include the facial outline of the head, the hair on the head and the nose on the face, which generally do not move in an animated face (at a least when the head is not moving and the line of sight of the observer is constant). The second layer is the combination of the ears, eyebrows, eyes (including the pupil and iris). The third layer is the combination of the mouth, lip and jaw positions and shapes. The third layer can present phoneme and emotional states of the character either alone, or in combination with the second layer, of which various combinations represent emotional states. While eight different version of the third layer can represent the expression of the different phoneme or sounds (consent and vowels) in the spoken English language, the combination of the elements of the 2^{nd} and third layer can used to depict a wide range of emotional states for the animated character.

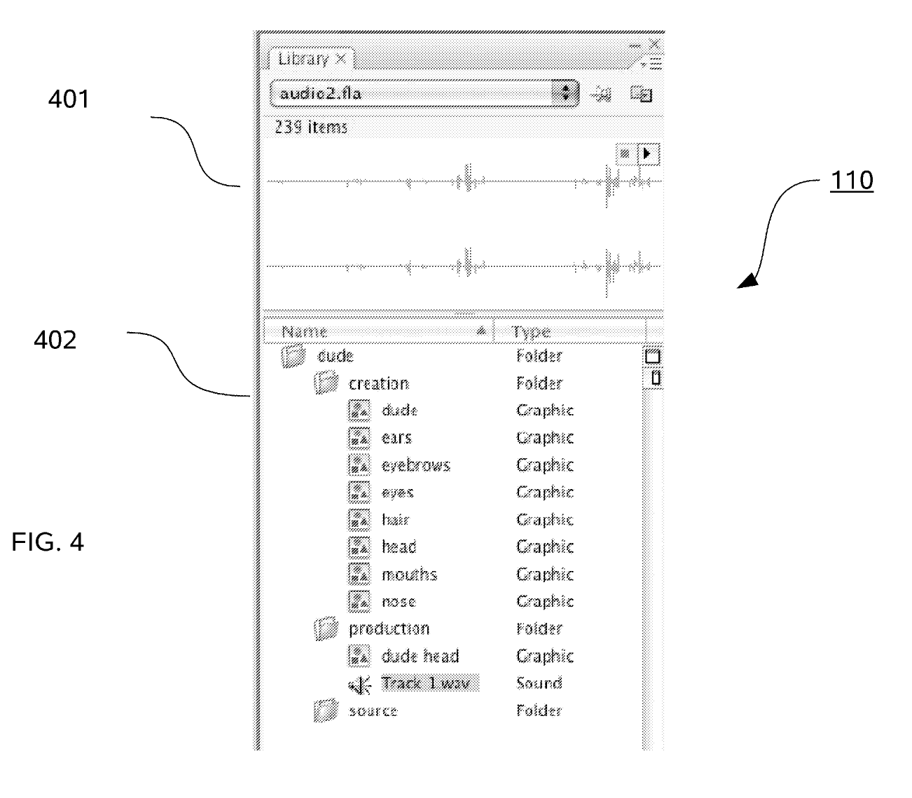

FIG. 4 illustrates how the GUI 100 can also be deployed to create characters in which window 110 now illustrates a top frame 401 with a wave of amplitude of an associated sound file placed within the production folder in lower frame 402 is a graphical representation of data files of the computer readable media used to create and animate a character named “DUDE” in the top level folder. Generally these data files are preferably organized in a series of 3 main files shown as a folder in the GUI frame 402, which are the creation, the source and the production folders. The creation folder is organized in a hierarchy with additional subfolder for parts of the facial anatomy, i.e. such as “Dude” for the outline of the head, ears, eyebrows etc. The user preferably edits all of their animations in the production folder, using artwork from the source as follows by opening each of the named folders; “creation”: stores the graphic symbols used to design the software user's characters, “source”: stores converted symbols—assets that can be used to animate the software user's characters, and “production”: stores the user's final lip-sync animations with sound, i.e. the “talking heads,”

The creation folder, along with the graphic symbols for each face part, is created the first time the user executes the command “New Character.” The creation folder along with other features described herein dramatically increases the speed at which a user can create and edit characters because similar assets are laid out on the same timeline. The user can view multiple emotion and position states at once and easily refer from one to another. This is considerably more convenient than editing each individual graphic symbol.

The source folder is created when the user executes the command “Creation Machine”. This command converts the creation folder symbols into assets that are ready to use for animating.

The production folder is where the user completes the final animation. The inventive software is preferably operative to automatically create this folder, along with an example animation file, when the user executes the Creation Machine command. Preferably, the software will automatically configure animations by copying assets from the source folder (not the creation folder). Alternately, when a user works or display their animation they can drag assets from the source folder (not the creation folder).

In the currently preferred embodiment, the data files represented by the above folder have the following requirements: a. Each character must have its own folder in the root of the Library. b. Each character folder must include a creation folder that stores all the graphic symbols that will be converted. c. At minimum, the creation folder must have a graphic symbol with the character's name, as well as a head graphic and d. All other character graphic symbols are optional. These include eyes, ears, hair, mouths, nose, and eyebrows. The user may also add custom symbols (whiskers, dimples, etc.) as long as they are only a single frame.

It should be appreciate that the limitation and requirements of this embodiment are not intended to limit the operation or scope of other embodiments, which can be an extension of the principles disclosed herein to animate more or less sophisticated characters.

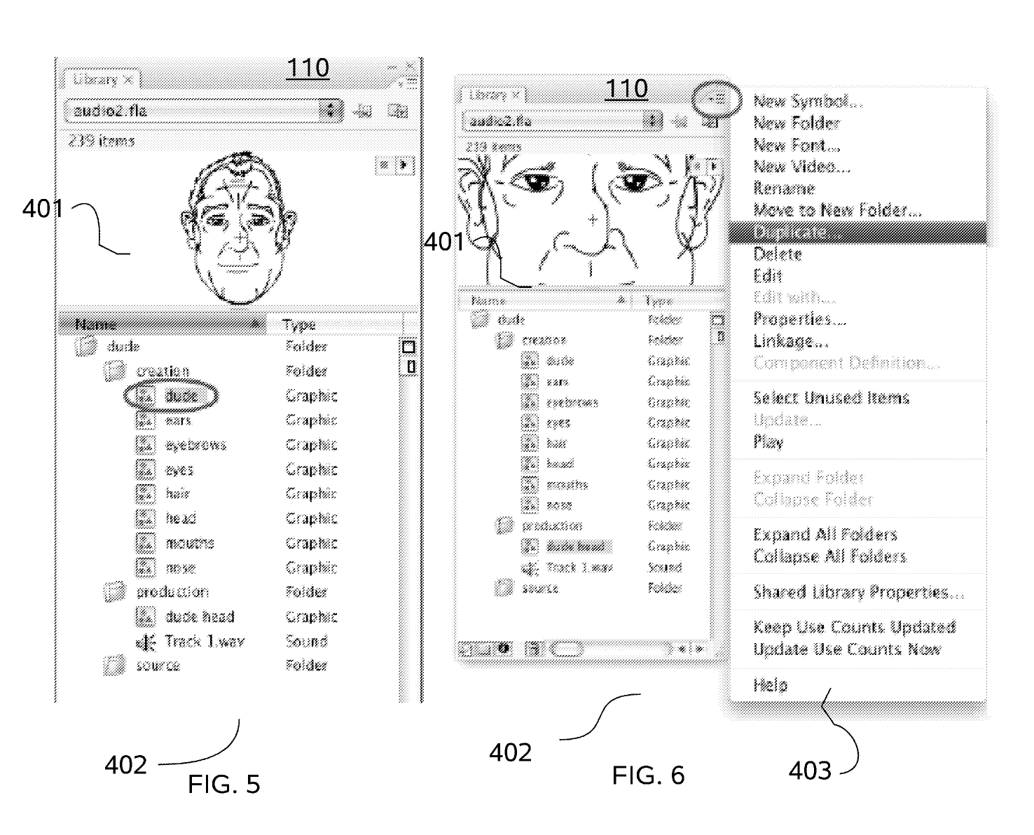

FIG. 5 illustrates a further step in using the GUI in FIG. 4. in which window 110 now illustrates a top frame 401 with the image of the anatomy selected in the source folder in lower frame 402 from creation subfolder “dude”, which is merely a head graphic (the head drawing without any facial elements on it), as the actual editing is preferably is performed in the larger winder 115.

FIG. 6 illustrates a further step in using the GUI in FIG. 5 in which “dude head” is selected in production folder in window 402, which then using the tab in the upper right corner of the frame opens another pull down menu 403, which in the current instance is activating a command to duplicate the object.

Thus, in the creation and editing of art work that fills frame 115 (of FIG. 1) an image 10 is synthesized (as directed by the user's activation of the computer input device to select aspects of facial morphology from the folders in frame 402) by the layering of a default image, or other parameter set, for the first layer, to which is added at least one of the selected second layer and the third layers.

It should be understood that this synthetic layering is to be interpreted broadly as a general means for combining digital representation of multiple images to form a final digital representation, by the application of a layering rule. According to the rule, the value of each pixel I each image frame of the video sequence in the final or synthesized layer is replaced by the value of the pixel in the preceding layers (in the order of highest to lower number) representing the same spatial position that does not have a zero or null value, (that might represent clear or white space, such as uncolored background).

While the ability to create and apply layers is a standard features of many computer drawing and graphics program, such as Adobe Flash® (Abode Systems, San Jose, Calif.), the novel means of creating characters and their facial components that represent different expressive states from templates provides a means to properly overlay the component elements in registry each time a new frame of the video sequence is created.

Thus, each emotional state to be animated is related to a grouping of different parameters sets for the facial morphology components in the second layer group. Each vowel or consonant phoneme to be illustrated by animation is related to a grouping of different parameter sets for the third layer group.

As the artwork for each layer group can be created in frame 115, using conventional computer drawing tools, while simultaneously viewing the underlying layers, the resulting data file will be registered to the underlying layers.

Hence, when the layers are combined to depict an emotional state for the character in a particular frame of the video sequence, such as by a predefined keyboard keystroke, the appropriate combination of layers will be combined in frame 115 in spatial registry.

When using the keyboard as the input device, preferably a first keystroke creates a primary emotion, which affects the entire face. A second keystroke may be applied to create a secondary emotion. In addition, third layer parameters for “lip syncing” can have image components that vary with the emotional state. For example, when the character is depicted as “excited”, the mouth can open wider when pronouncing specific vowels than it would in say an “inquisitive” emotional state.

Thus, with the above inventive methods, the combined use of the GUI and data structures stored on a computer readable media provides better quality animation of facial movement in coordination with a voice track. Further, images are synthesized automatically upon a keystroke or other rapid activation of a computer input device, the inventive method requires less user/animator time to achieve higher quality results. Further, even after animation is complete, further refinements and changes can be made to the artwork of each element of the facial anatomy without the need to re-animate the character. This facilities the work of animators and artists in parallel speeding production time and allowing for continuous refinement and improvement of a product.

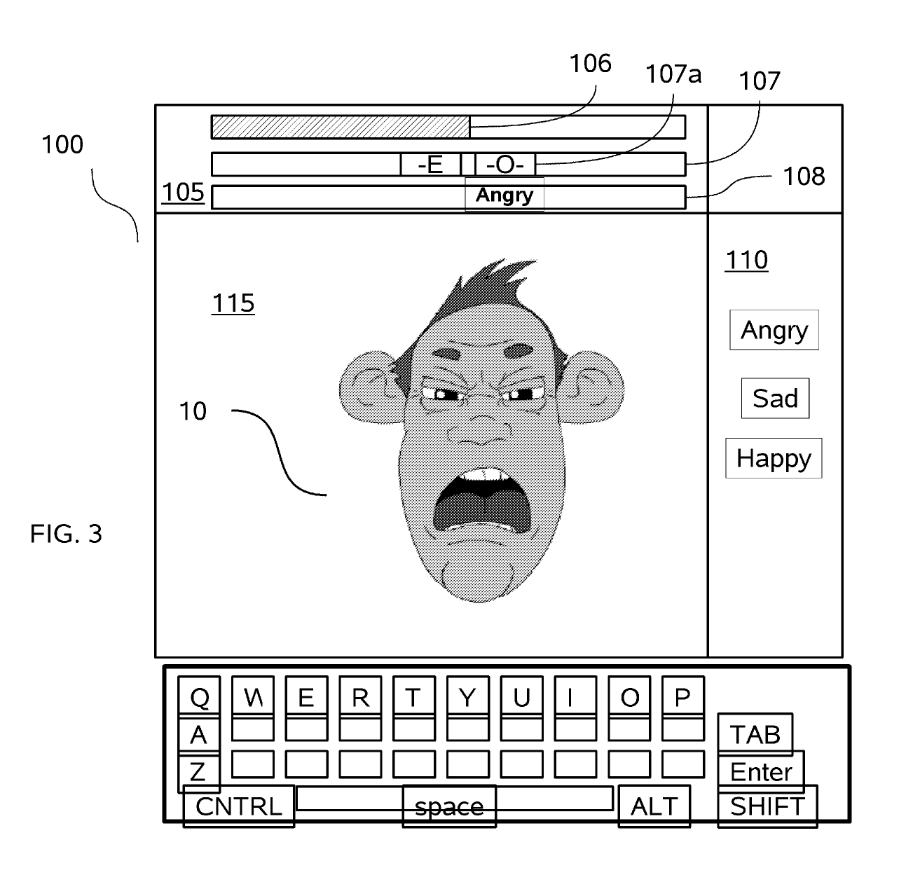

Although phoneme selection or emotional state selection is preferably done via the keyboard (as shown in FIG. 3 and as described further in the User Manual attached hereto as Appendix 1, which is incorporated herein by reference) it can alternatively be selected by actuating a corresponding state from any computer input device. Such a computer interface device may include a menu or list present in frame 110, as shown in FIG. 3. In this embodiment, frame 110 has a collection of buttons for selecting the emotional state.

The novel method described above utilizes the segmentation of the layer information in a number of data structures for creating the animated video frame sequences of the selected character. Ideally, each part of the face to be potentially illustrated in different expressions has a computer readable data file that correlates a plurality of unique pixel image maps to the selection option available via the computer input device.

In one such computer readable data structure there is a first data field containing data representing a plurality of phoneme, and a second data field containing data that is at least one of representing or being associated with an image of the pronunciation of a phoneme contained in the first data field, optionally either the first or another data field has data defining the keystroke or other computer user interface option that is operative to select the parameter in the first data field to cause the display of the corresponding element of the second data field in frame 115.

In other computer readable data structures there is a first data field containing data representing an emotional state, and a second data field containing data that is at least one of representing or being associated with at least a portion of a facial image associated with a particular emotional state contained in the first data field, with either the first data field or an optional third data field defining a keystroke or other computer user interface option that is operative to select the parameter in the first data field to cause the display of the corresponding element of the second data field in frame 115. This data structure can have additional data fields when the emotional state of the second data field is a collection of the different facial morphologies of different facial portions. Such an addition data field associated with the emotional state parameter in the first field includes at least one of the shape and position of the eyes, iris, pupil, eyebrows and ears.

The templates used to create the image files associated with a second data field are organized in a manner that provides a parametric value for the position or shape of the facial parts with an emotion. In creating a character, the user can modify the templates image files for each of the separate components of layer 2 in FIG. 2. Further, they can supplement the templates to add additional features. The selection process in creating the video frames can deploy previously defined emotions, by automatically layering a collection of facial characteristics. Alternatively, the animator can individually modify facial characteristics to transition or “fade” the animated appearance from one emotional state to another over a series of frames, as well as create additional emotional states. These transition or new emotional states can be created from templates and stored as additional image files for later selection with the computer input device.

The above and other embodiments of the invention are set forth in further details in Appendixes 1-4 of this application, being incorporated herein by reference, in which Appendix 1 is the User Manual for the “XPRESS”™ software product, which is authorized by the inventor hereof; Appendix 2 contains examples of normal emotion mouth positions; Appendix 3 contains examples of additional emotional states and Appendix 4 discloses further details of the source structure folders.

While the invention has been described in connection with a preferred embodiment, it is not intended to limit the scope of the invention to the particular form set forth, but on the contrary, it is intended to cover such alternatives, modifications, and equivalents as may be within the spirit and scope of the invention as defined by the appended claims.

We claim:

1. A method of character animation, the method comprising:
a) providing a general purpose computer having an electronic display and at least one user input means,
b) providing a data structure having at least a first and second data field, in which;
i) the first data field has at least one digital image that is a general facial portrait of a character to be animated on the electronic display, and
ii) the second data field has a first series of images that correspond to at least a portion of the facial morphology of the character to be animated that changes when the character to be animated appears to speaks, wherein each image of said first series is associated with a specific phoneme and is selectable via the user input means,
c) at least one of playing an audio sound track and reading a script to determine the sequence and duration of the phonemes intended to be spoken by the character to be animated,
d) selecting the appropriate phoneme via the user input means,
e) wherein the step of selecting the appropriate phoneme via the user input means causes the image associated with a specific phoneme to be overlaid on the general facial portrait image in temporal coordination with the sound track or script on the electronic display.

2. A method of character animation according to claim 1 further comprising providing a third data field having a second series of images that correspond to at least a portion of the facial morphology related to the emotional state of the character to be animated, wherein each image of the second series is associated with a specific emotional state and is selectable via the computer user input device.

3. A method of character animation according to claim 2 further wherein said step of:
a) at least one of playing an audio sound track and reading a script to determine the sequence and duration of the phonemes intended to be spoken by the character to be animated comprising comprises listening to a digital sound track to determine the emotional state of the animated character, and the additional step of:
b) causing the image that is associated with the appropriate emotional state to be overlaid on the general facial portrait image time in temporal coordination to the digital sound track on the electronic display by selecting the appropriate emotional state via the user input device.

4. A method of character animation according to claim 3 wherein;
a) said step of at least one of playing an audio sound track and reading a script to determine the sequence and duration of the phonemes intended to be spoken by the character to be animated comprising comprises listening to a digital sound track to determine the emotional state of the animated character, and;
b) wherein said step of causing the image that is associated with the appropriate emotional state to be overlaid on the general facial portrait image time in temporal coordination to the digital sound track on the electronic display by selecting the appropriate emotional state via the user input device causes a different image for at least one of the specific phoneme to be overlaid on the general facial portrait image on the electronic display in temporal coordination with the audio sound track than if another emotional state where selected.

5. A method of character animation according to claim 1 further comprising the step of changing at least one image from the first series of images after said step of selecting the appropriate phoneme associated with the changed image, said step of changing the at least one image being operative to change the appearance of all the further appearances of the at least one images that is overlaid on the general facial portrait image in temporal coordination with the digital sound track electronic display.

6. A method of character animation according to claim 2 further comprising the step of changing at least one image from the second series of images after said step of selecting the appropriate emotional state associated with the changed image, said step of changing the at least one image being operative to change the appearance of all the further appearance of the at least one images that is overlaid on the general facial portrait image in temporal coordination with the digital sound track.

7. A method of character animation according to claim 1 wherein the user input means is a keyboard.

8. A method of character animation according to claim 7 wherein the phoneme is selectable by a first key on the keyboard corresponding to the letter representing the sound of the phoneme and a second key on the keyboard to modify the phoneme selection by the length of the sound.

9. A method of character animation according to claim 8 wherein the second key on the keyboard does not represent a specific letter.

10. A computer readable media having a data structure for creating animated video frame sequences of characters, the data structure comprising:
a) a first data field containing data representing a phoneme that correlates with a selection mode of a computer user input device,
b) a second data field containing data that is at least one of representing or being associated with an image of the pronunciation of the phoneme contained in the first data field.

11. A computer readable media having a data structure for creating animated video frame sequences of characters, the data structure comprising:
a) a first data field containing data representing an emotional state that correlates with a selection mode of a computer user input device,
b) a second data field containing data that is at least one of representing or being associated with at least a portion of a facial image associated with a particular emotional state contained in the first data field.

12. A computer readable media having a data structure for creating animated video frame sequences of characters according to claim 11 further comprising,
a) a third data field containing data representing a phoneme,
b) a fourth data field containing data that is at least one of representing or being associated with an image of the pronunciation of the phoneme contained in the third data field.

13. A computer readable media having a data structure for creating animated video frame sequences of characters according to claim 12 further comprising,
a) a fifth data field containing data representing a phoneme,
b) a sixth data field containing data that is at least one of representing or being associated with an image of the pronunciation of the phoneme contained in the sixth data field.
c) wherein one of the emotional states in the first and second data fields is associated with the third and fourth data fields, and another of the emotional states in the first and second data fields is associated with the fifth and sixth data fields.

14. A GUI for character animation, the GUI comprising:
a) a first frame for displaying a graphical representation of the time elapsed in the play of a digital sound file,
b) a second frame for displaying at least parts of an image of an animated character for a video frame sequence in synchronization with the digital sound file that is graphically represented in the first frame,
c) at least one of an additional frame or a portion of the first and second frame for displaying a symbolic representation of the facial morphology for the animated character to be displayed in the second frame for at least a portion of the graphical representation of the time track in the first frame.

15. A GUI for character animation according to claim 14 wherein the facial morphology display in the at least one additional frame corresponds to different emotional states of the character to be animated with the GUI.

16. A GUI for character animation according to claim 14 wherein the facial morphology display in the at least one additional frame corresponds to the appearance of different phoneme as if the character to be animated were speaking.

17. A GUI for character animation according to claim 14 further comprising sub-frames of variable widths of elapsed playtime corresponding with the digital sound file to indicate the alternative parametric representation of the facial morphology.

18. A method of character animation, the method comprising:
a) providing a general purpose computer having an electronic display and at least one user input means,
b) providing a data structure having at least a first and second data field, in which;
i) the first data field has at least one digital image that is a general facial portrait of a character to be animated on the electronic display, and
ii) the second data field has a first series of images that correspond to at least a portion of the facial morphology of the character to be animated that changes when the character to be animated speaks, wherein each image of said first series is associated with a specific phoneme and is selectable via the user input device,
c) providing a means to select in sequence a plurality of phoneme from the second data field,
d) displaying the general facial portrait of the character to be animated on the electronic display,
e) wherein upon detection of a selected phoneme the general purpose computer is operative to overlay a corresponding image from the first series of image of the second data field on the general facial portrait image of the character to be animated on the electronic display.

19. A method of configuring a general purpose computer for creating animated video frame sequences of characters, the method comprising the steps of:
a) providing a computer readable media having thereon a set of computer instructions that is operative to create the GUI of claim 14.

20. A method of configuring a general purpose computer for creating animated video frame sequences of characters according to claim 19 wherein the computer readable media further comprises the data structure of claim 10.
